(19) United States
(12) Patent Application Publication
(10) Pub. No.: US 2025/0229517 A1
(43) Pub. Date: Jul. 17, 2025

(54) FILM STICKING DEVICE AND FILM STICKING METHOD THEREOF

(71) Applicant: Dongguan Pinjia Technology Co., Ltd., Dongguan (CN)

(72) Inventor: Xiaofen Liu, Dongguan (CN)

(21) Appl. No.: 18/631,085

(22) Filed: Apr. 10, 2024

(30) Foreign Application Priority Data
Jan. 15, 2024 (CN) 202410056043.5

(51) Int. Cl. B32B 37/00; B32B 37/26

(52) U.S. Cl. CPC B32B 37/0046; B32B 37/26; B32B 2037/268; B32B 2457/20

(57) ABSTRACT

The present disclosure discloses a film sticking device, including a dust-free housing for connecting a screen film and a mobile terminal. The screen film has a positioning film, a protective film, a release film, and a pulling member that are sequentially placed and attached together. A double-sided adhesive member is attached between the positioning film and the release film; wherein a through hole is defined in one side of the positioning film adjacent to the double-sided adhesive member, and the double-sided adhesive member between the positioning film and the release film is located directly above the through hole; in a working state, the release film and the double-sided adhesive member are depressed downwards depressed downwards and are deformed, the double-sided adhesive member passes through the through hole, and a bottom surface of the double-sided adhesive member is attached to a surface of the dust-free housing.

### CROSS-REFERENCE TO RELATED APPLICATIONS

The present disclosure claims the priority of Chinese Patent Application No. 202410056043.5, filed on Jan. 15, 2024, the entire contents of which are hereby incorporated by reference.

### FIELD

The present disclosure relates to the technical field of filming sticking equipment, and more particularly, relates to a film sticking device and a film sticking method thereof.

### BACKGROUND

With the advent of the Internet age, electronic devices have increasingly become an indispensable tool in our lives. However, a screen of the electronic device is too fragile and often gets scratched or even shattered inadvertently, which affects the display effect and aesthetics of the electronic device. It costs a lot of money and takes a lot of time to replace the screen, thus people usually apply a positioning film on the screen of the electronic device to protect the tablet or the screen of the mobile phone.

In real life, a film sticking tool is usually used to assist in sticking a film on the screen of the mobile phone or the mobile terminal. A dust-free housing and a screen film kit are typically used together for sticking the film. However, during actual use, the dust-free housing may accidentally drop when being placed upside down to cover the mobile terminal, causing the placed screen film kit to fall out of the dust-free housing.

To solve this problem, manufacturers arranges a double-sided adhesive tape to an end between the dust-free housing and the positioning film and a double-sided adhesive tape between a release film and the positioning film. With the adhesive force of the double-sided adhesive tape, the screen film kit can be prevented from falling out of the dust-free housing when the dust-free housing drops to the ground.

Therefore, there is room for improving the structure and components of this existing film sticking tool to achieve the goal of reducing the production cost.

The above information disclosed in the background section is only used to enhance the understanding of the background of the present disclosure, and therefore may include the information that does not constitute the prior art known to those of ordinary skill in the art.

### SUMMARY

The purpose of the present disclosure is to provide a film sticking device, which improves the existing product by reducing a number of required double-sided adhesive tapes and thus reduces the production cost. The present disclosure further provides a film sticking method applied in the film sticking device.

According to a first aspect of the present disclosure, a film sticking device is provided, including a dust-free housing for connecting a screen film and a mobile terminal; the screen film having a positioning film, a protective film, a release film, and a pulling member arranged in sequence, and a double-sided adhesive member being attached between the positioning film and the release film; wherein a through hole is defined in one side of the positioning film adjacent to the double-sided adhesive member, and the double-sided adhesive member between the positioning film and the release film is located directly above the through hole; in a working state, the release film and the double-sided adhesive member are depressed downwards and are deformed, the double-sided adhesive member passes through the through hole, and a bottom surface of the double-sided adhesive member is attached to a surface of the dust-free housing.

In some embodiments, the double-sided adhesive member is provided as a double-sided adhesive tape.

With the double-sided adhesive tape, the double-sided adhesive member is capable of providing adhesive forces on both sides thereof.

In some embodiments, the double-sided adhesive member is integrally shaped as a rectangle, and the through hole is shaped as a rectangular hole matching with the double-sided adhesive member.

The double-sided adhesive member shaped as a rectangle can contact the surface of the dust-free housing after passing through the through hole, which forms a planar attachment between the double-sided adhesive member and the dust-free housing to improve the adhesive force.

In some embodiments, an overall size of the double-sided adhesive member is 1.1-1.5 times an overall size of the through hole, such that an outer ring of the double-sided adhesive member is attached to a top surface of the positioning film and a middle portion of the double-sided adhesive member does not contact the positioning film.

In some embodiments, a fool-proof through slot is formed at one end of the positioning film, and a fool-proof protrusion matching with the fool-proof through slot is connected to a top surface of the dust-free housing.

With the engagement between the fool-proof protrusion and the fool-proof through slot, sides of the positioning film, the protective film, the release film, and the pulling member adjacent to the fool-proof can be centered.

In some embodiments, the dust-free housing includes a bottom plate, two symmetrically-distributed limiting rib plates connected to a top surface of the bottom plate, and a drawing slot formed in one end of each of the limiting rib plate away from the fool-proof protrusion; and the pulling member passes through the drawing slot and is slidably connected to the drawing slot.

In some embodiments, a double-sided adhesive sheet is mounted on a side of the top surface of the bottom plate away from the double-sided adhesive member.

The double-sided adhesive member and the double-sided adhesive sheet are capable of preventing the accidental dropping of the dust-free housing which may cause the positioning film, the protective film, the release film, and the pulling member to drop out of the dust-free housing.

In some embodiments, two sides of one end of the positioning film which is away from the double-sided adhesive member are respectively connected to two centering ears, and the centering ear is in contact with a side wall of the corresponding limiting rib plate.

The centering ears are capable of centering one side of the positioning film away from the fool-proof protrusion.

According to a second aspect of the present disclosure, a film-sticking method applied in the above film sticking device according to is provided, including:
S1, arranging the screen film into the dust-free housing such that the positioning film contacts the top surface of the dust-free housing, pressing the pulling member such that the release film and the double-sided adhesive member are deformed downwards under a pressure and the double-sided adhesive member passes through the through hole, until the bottom surface of the double-sided adhesive member is attached to the surface of the dust-free housing;
S2, moving the dust-free housing to be directly above a mobile terminal, such that a screen of the mobile terminal directly faces the protective film, and gradually moving the dust-free housing downwards to cover and enclose the mobile terminal, such that the screen of the mobile terminal is attached to a surface of the pulling member;
S3, pulling the pulling member outwards along a lengthwise direction, wherein the pulling member drives the release film to separate from the protective film such that the release film is no longer attached to the surface of the dust-free housing and contacts the screen of the mobile terminal to absorb dust; and
S4, when the release film layer is completely removed, drawing a straight line along the lengthwise direction on a middle portion of the positioning film, such that the positioning film drives the protective film to be gradually attached to the screen of the mobile terminal from the middle portion thereof automatically.

In the above technical solution, the present disclosure provides the following technical effects and advantages:

Firstly, in the technical solution of the present disclosure, the double-sided adhesive member originally arranged between the dust-free housing and the positioning film can be omitted, and the double-sided adhesive member between the positioning film and the release film can be attached to the surface of the dust-free housing through the through hole defined in the positioning film, which not only achieves the effect of the original product, but also reduces the number of the required double-sided adhesive member, reducing the production cost.

Secondly, with the centering ears mounted on two sides of the end of the positioning film away from the fool-proof protrusion, cooperating with the fool-proof through slot and the fool-proof protrusion, the positioning film, the protective film, the release film, and the pulling member can be further centered in the dust-free housing to further improve the quality of film sticking.

Thirdly, by designing the dimensions between the through hole and the double-sided adhesive member, the outer ring of the double-sided adhesive member can be attached to the positioning film and the release film as in the prior art, and the middle portion of the protective film can sink to contact the surface of the dust-free housing.

### BRIEF DESCRIPTION OF THE DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a schematic diagram of a film sticking device in a using state in accordance with an embodiment of the present disclosure;

FIG. 2 is a schematic diagram showing the installation of a screen film in accordance with an embodiment of the present disclosure;

FIG. 3 is an exploded view of the screen film viewed from a first angle; and

FIG. 4 is an exploded view of the screen film viewed from a second angle.

### DESCRIPTION OF REFERENCE NUMERALS

1, dust-free housing; 101, bottom plate; 102, limiting rib plate; 103, drawing slot; 2, positioning film; 3, protective film; 4, release film; 5, pulling member; 6, double-sided adhesive member; 7, through hole; 8, fool-proof through slot; 9, fool-proof protrusion; 10. double-sided adhesive sheet; and 11, centering ear.

### DETAILED DESCRIPTION

In order to enable those skilled in the art to better understand the technical solutions in this application, the technical solutions in the embodiments of this application will be clearly and completely described below. Obviously, the described embodiments are only a part of the embodiments of this application, not all of them. Based on the embodiments of this application, all other embodiments obtained by those skilled in the art without creative work belong to the scope of protection of the present disclosure.

In order to better understand the above technical solutions, the following will provide detailed descriptions of the above technical solutions in conjunction with the accompanying drawings and specific implementation methods.

### Embodiment 1

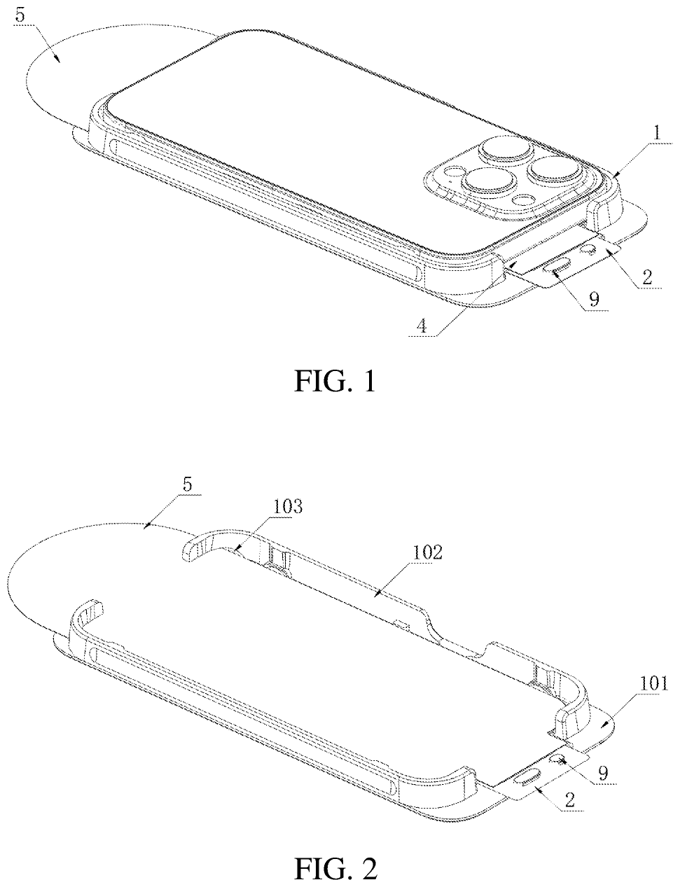

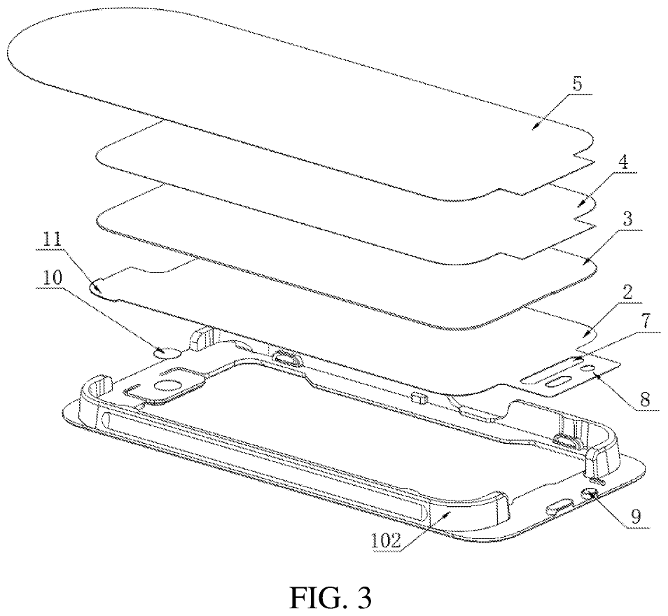

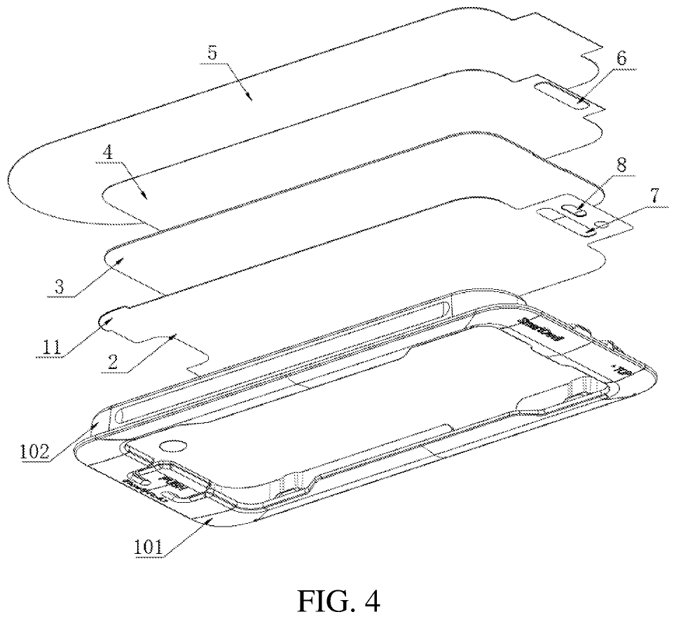

As shown in FIGS. 1 to 4, a film sticking device in accordance with an embodiment of the present disclosure is provided, including a bottom plate 101, two symmetrically-arranged limiting rib plates 102 connected to a top surface of the bottom plate 101, and a drawing slot 103 formed at one end of each limiting rib plate 102 away from a fool-proof protrusion 9. The fool-proof protrusion 9 is connected to a side of a top surface of the bottom plate 101 away from the drawing slot 103. A double-sided adhesive sheet 10 is connected to a side of the top surface of the bottom plate 101 adjacent to the drawing slot 103. A positioning film 2, a protective film 3, a release film 4, and a pulling member 5 are sequentially attached together on the two limiting rib plates 102 from bottom to top, and the pulling member 5 passes through the drawing slot 103. A fool-proof through slot 8 matching with the fool-proof protrusion 9 is formed in the positioning film 2. A double-sided adhesive member 6 is arranged between the positioning film 2 and the release film 4, and a through hole 7 is defined in the positioning film 2 and is located directly below the double-sided adhesive member 6. Both sides of one end of the positioning film 2 which is away from the fool-proof protrusion 9 are respectively connected to two centering ears 11.

Before sticking the film on a mobile terminal, the user can firstly place the positioning film 2, the protective film 3, the release film 4, and the pulling member 5 that are arranged in sequence between the two limiting rib plates 102, such that the fool-proof protrusion 9 is engaged in the fool-proof through slot 8 and the pulling member 5 is pushed into the drawing slot 103. At this time, the centering ears 11 arranged on both sides of the positioning film 2 contact surfaces of the limiting rib plates 102, and cooperate with the fool-proof protrusion 9 and the fool-proof through slot 8 to center the positioning film 2, the protective film 3, the release film 4, and the pulling member 5. Then, the pulling member 5 arranged on a top surface of the double-sided adhesive member 6 is pressed, such that the release film 4 and the double-sided adhesive member 6 are deformed downwards, allowing one side of the double-sided adhesive member 6 away from the release film 4 to pass through the through hole 7 and is attached to a surface of the bottom plate 101, and meanwhile allowing the double-sided adhesive sheet 10 to be attached to a bottom surface of the protective film 3.

Afterwards, the mobile terminal is placed on a surface of the pulling member 5, with a screen of the mobile terminal facing downwards. The mobile terminal is pressed downwards, allowing the mobile terminal to enter a spaced defined between the two limiting rib plates 102, which can be followed by the existing film sticking process.

### Embodiment 2

In this embodiment, a film sticking method applied in the film sticking device of Embodiment 1 is provided, which includes steps as follows.

S1, arranging an assembled screen film inside the dust-free housing 1, aligning the fool-proof through slot 8 in the positioning film 2 with the fool-proof protrusion 9 on the dust-free housing 1, such that the centering ears 11 on both sides of the positioning film 2 contact side walls of the limiting rib plates 102 to center the positioning film 2; pressing the pulling member 5 such that the release film 4 and the double-sided adhesive member 6 are deformed downwards under a pressure, allowing two sides of an outer ring of the double-sided adhesive member 6 to stick the release film 4 and the positioning film 2 together, and allowing a middle portion of the double-sided adhesive member 6 to pass through the through hole 7 until a bottom surface of the double-sided adhesive member 6 is attached to a surface of the dust-free housing 1.

S2, moving the dust-free housing 1 until the dust-free housing 1 is directly located above the mobile terminal, with the screen of the mobile terminal facing upwards, such that the screen of the mobile terminal directly faces the protective film 3; and gradually moving the dust-free housing 1 downwards until the dust-free housing 1 covers and encloses the mobile terminal, allowing the screen of the mobile terminal to be attached to the surface of the pulling member 5.

S3, pulling the pulling member 5 outwards along a lengthwise direction, wherein the pulling member 5 drives the release film 4 to separate from the protective film 3, such that the release film 4 is no longer attached to the surface of the dust-free housing 1, and then the release film 4 contacts the screen of the mobile terminal to absorb dust.

S4, after the release film 4 is completely separated from the protective film 3, drawing a straight line along the lengthwise direction on a middle portion of the positioning film 2, such that the positioning film 2 drives the protective film 3 to sink, and the protective film 3 is gradually attached to the screen of the mobile terminal from the middle portion thereof automatically.

As stated above, after the screen film is installed on the dust-free housing 1, since the double-sided adhesive member 6 is attached to the surface of the dust-free housing 1, the double-sided adhesive member 6 is capable of preventing the screen film from separating from the dust-free housing 1 when the handheld dust-free housing 1 accidentally drops.

During the actual installation process, after the installation of the screen film, the screen film can be rapidly stuck to the screen by covering the dust-free housing 1 on the mobile terminal, pulling the pulling member 5, and drawing a straight line on the positioning film 2.

The above description only describes some exemplary embodiments of the present disclosure by way of illustration. It goes without saying that those skilled in the art can modify the described embodiments in various ways without departing from the spirit and scope of the present disclosure. Therefore, the above drawings and description are illustrative in nature and should not be construed as limiting the scope of protection of the claims of the present disclosure.

The embodiments disclosed above are described to enable a person skilled in the art to implement or use this application. Various modifications made to the embodiments described above are obvious to a person skilled in the art, and the general principles defined in this specification may also be implemented in other embodiments without departing from the spirit or scope of the present disclosure. Therefore, the present disclosure is not limited to these embodiments described in this specification, but shall be construed in a widest scope consistent with the principles and novel features disclosed in this specification.

Finally, it should be noted that the above embodiments are only used to illustrate the technical solutions of the present disclosure and are not limitations. Although the present disclosure has been described in detail with reference to preferred embodiments, those skilled in the art should understand that the technical solutions of the present disclosure can be modified or equivalently replaced without departing from the spirit and scope of the technical solutions of the present disclosure.

What is claimed is:

1. A film sticking device comprising a dust-free housing (1) for connecting a screen film and a mobile terminal; the screen film having a positioning film (2), a protective film (3), a release film (4), and a pulling member (5) arranged in sequence, and a double-sided adhesive member (6) being attached between the positioning film (2) and the release film (4); wherein a through hole (7) is defined in one side of the positioning film (2) adjacent to the double-sided adhesive member (6), and the double-sided adhesive member (6) between the positioning film (2) and the release film (4) is located directly above the through hole (7); in a working state, the release film (4) and the double-sided adhesive member (6) are depressed downwards and are deformed, the double-sided adhesive member (6) passes through the through hole (7), and a bottom surface of the double-sided adhesive member (6) is attached to a surface of the dust-free housing (1).

2. The film sticking device according to claim 1, wherein the double-sided adhesive member (6) is provided as a double-sided adhesive tape.

3. The film sticking device according to claim 1, wherein the double-sided adhesive member (6) is integrally shaped as a rectangle, and the through hole (7) is shaped as a rectangular hole matching with the double-sided adhesive member (6).

4. The film sticking device according to claim 3, wherein an overall size of the double-sided adhesive member (6) is 1.1-1.5 times an overall size of the through hole (7), such that an outer ring of the double-sided adhesive member (6) is attached to a top surface of the positioning film (2) and a middle portion of the double-sided adhesive member (6) does not contact the positioning film (2).

5. The film sticking device according to claim 1, wherein a fool-proof through slot (8) is formed at one end of the positioning film (2), and a fool-proof protrusion (9) matching with the fool-proof through slot (8) is connected to a top surface of the dust-free housing (1).

6. The film sticking device according to claim 5, wherein the dust-free housing (1) comprises a bottom plate (101), two symmetrically-distributed limiting rib plates (102) connected to a top surface of the bottom plate (101), and a drawing slot (103) formed in one end of each of the limiting rib plate (102) away from the fool-proof protrusion (9); and the pulling member (5) passes through the drawing slot (103) and is slidably connected to the drawing slot (103).

7. The film sticking device according to claim 6, wherein a double-sided adhesive sheet (10) is mounted on a side of the top surface of the bottom plate (101) away from the double-sided adhesive member (6).

8. The film sticking device according to claim 5, wherein two sides of one end of the positioning film (2) which is away from the double-sided adhesive member (6) are respectively connected to two centering ears (11), and the centering ear (11) is in contact with a side wall of the corresponding limiting rib plate (102).

9. A film-sticking method applied in the film sticking device according to claim 1, comprising the following steps:
S1, arranging the screen film into the dust-free housing (1) such that the positioning film (2) contacts the top surface of the dust-free housing (1), pressing the pulling member (5) such that the release film (4) and the double-sided adhesive member (6) are deformed downwards under a pressure and the double-sided adhesive member (6) passes through the through hole (7), until the bottom surface of the double-sided adhesive member (6) is attached to the surface of the dust-free housing (1);
S2, moving the dust-free housing (1) to be directly above a mobile terminal, such that a screen of the mobile terminal directly faces the protective film (3), and gradually moving the dust-free housing (1) downwards to cover and enclose the mobile terminal, such that the screen of the mobile terminal is attached to a surface of the pulling member (5);
S3, pulling the pulling member (5) outwards along a lengthwise direction, wherein the pulling member (5) drives the release film (4) to separate from the protective film (3) such that the release film (4) is no longer attached to the surface of the dust-free housing (1) and contacts the screen of the mobile terminal to absorb dust; and
S4, when the release film (4) layer is completely removed, drawing a straight line along the lengthwise direction on a middle portion of the positioning film (2), such that the positioning film (2) drives the protective film (3) to be gradually attached to the screen of the mobile terminal from the middle portion thereof automatically.

10. The film sticking method according to claim 9, wherein the double-sided adhesive member (6) is provided as a double-sided adhesive tape.

11. The film sticking method according to claim 9, wherein the double-sided adhesive member (6) is integrally shaped as a rectangle, and the through hole (7) is shaped as a rectangular hole matching with the double-sided adhesive member (6).

12. The film sticking method according to claim 11, wherein an overall size of the double-sided adhesive member (6) is 1.1-1.5 times an overall size of the through hole (7), such that an outer ring of the double-sided adhesive member (6) is attached to a top surface of the positioning film (2) and a middle portion of the double-sided adhesive member (6) does not contact the positioning film (2).

13. The film sticking method according to claim 9, wherein a fool-proof through slot (8) is formed at one end of the positioning film (2), and a fool-proof protrusion (9) matching with the fool-proof through slot (8) is connected to a top surface of the dust-free housing (1).

14. The film sticking method according to claim 13, wherein the dust-free housing (1) comprises a bottom plate (101), two symmetrically-distributed limiting rib plates (102) connected to a top surface of the bottom plate (101), and a drawing slot (103) formed in one end of each of the limiting rib plate (102) away from the fool-proof protrusion (9); and the pulling member (5) passes through the drawing slot (103) and is slidably connected to the drawing slot (103).

15. The film sticking method according to claim 14, wherein a double-sided adhesive sheet (10) is mounted on a side of the top surface of the bottom plate (101) away from the double-sided adhesive member (6).

16. The film sticking method according to claim 13, wherein two sides of one end of the positioning film (2) which is away from the double-sided adhesive member (6) are respectively connected to two centering ears (11), and the centering ear (11) is in contact with a side wall of the corresponding limiting rib plate (102).
